(19) United States
(12) Patent Application Publication
(10) Pub. No.: US 2024/0177727 A1
(43) Pub. Date: May 30, 2024

(54) METHOD PERFORMED BY ELECTRONIC DEVICE AND APPARATUS

(71) Applicant: SAMSUNG ELECTRONICS CO., LTD., Suwon-si (KR)

(72) Inventors: Wei LIU, Beijing (CN); Lei YANG, Beijing (CN); Lufen TAN, Beijing (CN)

(73) Assignee: SAMSUNG ELECTRONICS CO., LTD., Suwon-si (KR)

(21) Appl. No.: 18/521,606

(22) Filed: Nov. 28, 2023

(30) Foreign Application Priority Data
Nov. 28, 2022 (CN) 202211505381.X

(51) Int. Cl. G10L 21/0308; G10L 25/60

(52) U.S. Cl. CPC G10L 21/0308; G10L 25/60

(57) ABSTRACT

The present disclosure provides a method performed by an electronic device and an apparatus. A method performed by an electronic device may include: obtaining an audio signal comprising a speech signal uttered by at least one sound source; determining a target audio segment of the audio signal, wherein the target audio segment is determined based on a speech quality of at least one audio segment, wherein the at least audio segment is divided from the audio signal; and performing speech separation on the audio signal based on the target audio segment to obtain at least one separated speech signal corresponding to the at least one sound source.

### CROSS-REFERENCE TO RELATED APPLICATION(S)

The present application claims priority under 35 U.S.C. § 119 to Chinese Patent Application No. 202211505381.X, filed with the China National Intellectual Property Administration on Nov. 28, 2022, the disclosure of which are incorporated by reference herein in its entirety.

### FIELD

The present disclosure relates to the fields of speech processing and artificial intelligence, and in particular, to a method performed by an electronic device and an apparatus.

### BACKGROUND

Currently, in the field of speech separation, deep learning-based speech separation algorithms have surpassed traditional signal processing, and the high nonlinear modeling capabilities of deep learning-based speech separation algorithms may achieve better results in the task. Among the methods of deep learning, recurrent neural networks are particularly suitable for describing input data with sequence relationships in natural language and time sequence due to their natural timing-sequence-dependent nature, which is an important component of modern intelligent speech processing systems, and their recurrent connections are crucial for learning long sequence relationships of speech and correctly managing speech context. However, since computation of a next step of the recurrent neural network relies on hidden layer states output in a previous step, the existing speech separation schemes cannot accurately separate the speech signals of each sound source when there is no sound source signal to be separated within a certain period of time, and the separation accuracy needs to be further optimized.

### SUMMARY

The exemplary embodiments of the present disclosure provide a method performed by an electronic device and a device that solve at least the above technical problem and other technical problems not mentioned above, and provide the following beneficial effects.

According to an aspect of the exemplary embodiments of the present application, there is provided a method performed by an electronic device, the method may include: obtaining an audio signal comprising a speech signal uttered by at least one sound source; determining a target audio segment of the audio signal, wherein the target audio segment is determined based on a speech quality of at least one audio segment, wherein the at least audio segment is divided from the audio signal; and performing speech separation on the audio signal based on the target audio segment to obtain at least one separated speech signal corresponding to the at least one sound source.

According to an aspect of the exemplary embodiments of the present application, there is provided a method performed by an electronic device, the method may include: obtaining a training sample, wherein the training sample includes a speech signal uttered by at least one sound source in a noiseless environment and an audio signal composed of the speech signal and a noise signal; determining, by an audio segment search module included in a speech processing model, a target audio segment of the audio signal, wherein the target audio segment is determined based on speech quality of each audio segment divided from the audio signal; performing, by a separation module included in the speech processing model, speech separation on the audio signal according to the target audio segment, to obtain a separated speech signal corresponding to each sound source; adjusting parameters of the speech processing model based on the obtained speech signal and the corresponding separated speech signal.

According to an aspect of the exemplary embodiments of the present application, there is provided an electronic device, the electronic device includes: at least one memory storing computer executable instructions; and at least one processor. The at least one processor, when executing the stored instructions, is configured to: obtain an audio signal comprising a speech signal uttered by at least one sound source; determine a target audio segment of the audio signal, wherein the target audio segment is determined based on a speech quality of at least one audio segment, wherein the at least audio segment is divided from the audio signal; and perform speech separation on the audio signal based on the target audio segment to obtain at least one separated speech signal corresponding to the at least one sound source.

The computer executable instructions may include first obtaining code configured to cause the at least one processor to obtain an audio signal to be processed, wherein the audio signal comprises a speech signal uttered by at least one sound source; first determining code configured to cause the at least one processor to determine a target audio segment of the audio signal, wherein the target audio segment is determined based on a speech quality of each audio segment, wherein each audio segment is divided from the audio signal; and first performing code configured to cause the at least one processor to perform speech separation on the audio signal based on the target audio segment to obtain a separated speech signal corresponding to each sound source.

According to an aspect of the exemplary embodiments of the present application, there is provided a non-transitory computer readable storage medium storing instructions that, when executed by at least one processor, cause the at least one processor to obtain an audio signal comprising a speech signal uttered by at least one sound source; determine a target audio segment of the audio signal, wherein the target audio segment is determined based on a speech quality of at least one audio segment, wherein the at least audio segment is divided from the audio signal; and perform speech separation on the audio signal based on the target audio segment to obtain at least one separated speech signal corresponding to the at least one sound source.

According to an aspect of the exemplary embodiments of the present application, there is provided a computer program product in which instructions are executed by at least one processor in an electronic device to perform the above method.

By using a modeling method of adaptively connecting target audio segments to separate each sound source signal from the audio signal, the present disclosure can not only solve the problem of long-term forgetting of the prediction network, but also significantly improve the accuracy of speech separation.

### BRIEF DESCRIPTION OF THE DRAWINGS

These and/or other aspects and advantages of the present disclosure will become clear and easier to understand from the following description of the embodiments in conjunction with the accompanying drawings, wherein:

FIG. 1 is a flow diagram of a speech processing method according to an exemplary embodiment of the present disclosure.

FIG. 2 is a flow diagram of a speech processing method according to another exemplary embodiment of the present disclosure.

FIG. 3 is a flow chart of a speech processing method according to an exemplary embodiment of the present disclosure.

FIG. 4 shows a schematic diagram of searching for a high-quality audio segment according to an exemplary embodiment of the present disclosure.

FIG. 5 shows a schematic diagram of a traditional calculation method of speech distortion.

FIGS. 6 and 7 show schematic diagrams of calculating speech distortion according to the present disclosure.

FIG. 8 shows a schematic diagram of a sub band-based encoding module according to an exemplary embodiment of the present disclosure.

FIG. 9 shows a schematic diagram of fixed path modeling of the prior art.

FIG. 10 shows a schematic diagram of feature separation according to an exemplary embodiment of the present disclosure.

FIG. 11 shows a schematic diagram of fusing hidden layer state information according to an exemplary embodiment of the present disclosure.

FIG. 12 shows a schematic flowchart of fusing hidden layer state information by using a timing processing network according to an exemplary embodiment of the present disclosure.

FIG. 13 shows a schematic diagram of a process for feature separation according to an exemplary embodiment of the present disclosure.

FIG. 14 shows a schematic diagram of a local splitting mode according to an exemplary embodiment of the present disclosure.

FIG. 15 shows a schematic diagram of a global splitting mode according to an exemplary embodiment of the present disclosure.

FIG. 16 shows a schematic diagram of performing feature separation on a feature vector v_global by a second LSTM according to an exemplary embodiment of the present disclosure.

FIG. 17 shows a schematic diagram of performing feature separation by an adaptive path separation module according to an exemplary embodiment of the present disclosure.

FIG. 18 shows a schematic diagram of a subband-based decoding module according to an exemplary embodiment of the present disclosure.

FIG. 19 shows a schematic diagram of speech separation in a multi-person meeting scenario according to an exemplary embodiment of the present disclosure.

FIG. 20 shows a schematic diagram of speech separation of a video according to an exemplary embodiment of the present disclosure.

FIG. 21 is a flowchart of a training method for a speech processing model according to an exemplary embodiment of the present disclosure.

FIG. 22 is a block diagram of a speech processing device according to an exemplary embodiment of the present disclosure.

FIG. 23 is a block diagram of a training device for a speech processing model according to an exemplary embodiment of the present disclosure.

FIG. 24 shows a schematic structural diagram of a speech processing apparatus in hardware operating environment according to an exemplary embodiment of the present disclosure.

FIG. 25 is a block diagram of an electronic device according to an embodiment of the present disclosure.

### DETAILED DESCRIPTION

In order to make those skilled in the art better understand the technical solutions of the present disclosure, the technical solutions in the embodiments of the present disclosure will be clearly and completely described below with reference to the accompanying drawings.

The following description with reference to the attached drawings is provided to assist in a complete understanding of the embodiments of the present disclosure as defined by the claims and their equivalents. A variety of specific details are included to assist in understanding, but these details are considered only exemplary. Thus, those skilled in the art will be aware that the embodiments described herein may be subject to various changes and modifications without departing from the scope and spirit of the present disclosure. In addition, the description of the function and structure of the common knowledge is omitted for clarity and brevity.

The terms and words used in the following description and claims are not limited to the written meaning and are used only by the inventor to achieve a clear and consistent understanding of the present disclosure. Accordingly, it should be clear to those skilled in the art that the following description of the various embodiments of the present disclosure is provided only for illustrative purposes and not to limit the purposes of the present disclosure defined by the claims and their equivalents.

It should be noted that the terms “first”, “second” and the like in the description and claims as well as the above drawings of the present disclosure are used to distinguish similar objects and are not necessarily used to describe a specific order or sequence. It should be understood that the data used in this way may be interchanged under appropriate circumstances, so that the embodiments of the present disclosure described herein can be implemented in an order other than those illustrated or described herein. The embodiments described in the following exemplary embodiments are not representative of all embodiments consistent with the present disclosure. Rather, they are only examples of devices and methods consistent with some aspects of the present disclosure as detailed in the appended claims.

Existing speech separation schemes have the problem of long-term forgetting. When a speaker keeps quiet and does not speak for a long time (for example, 1-5 minutes), the speech separation networks will suffer from the problem of separation errors which are caused by the following two main reasons:

The existing speech separation networks need to learn features of speakers, such as speaker's pronunciation habits, rhythm, intonation, etc., and use the learned features of the speakers to separate the speakers' voices from a mixed speech signal. Take an intelligent meeting scenario as an example, when a speaker A finishes speaking and a speaker B starts to speak, if the speaker A keeps quiet (for example, 1-5 minutes), the speech separation network will gradually forget speech features of the speaker A, which will result in incorrect separation results.

In addition, the optimal number of iterations of existing speech separation neural networks is between 200 and 300. If the number of iterations exceeds this interval, the performance of the neural network will be reduced. However, in the speech separation network, a time interval of a global path for connecting audio units of each audio segment is about 20 ms. If a signal of 1 to 5 minutes is processed, the number of iterations of the global path will be as high as 3000 to 15000, which will lead to a serious problem of long-term forgetting in the network.

In order to improve the existing technology and enable the neural network to retain users' features even when the users do not speak for a long time, the present disclosure presents a new speech separation algorithm that adaptively connects high-quality audio segments of a speaker (also known as target audio segments). Here, the high-quality audio segments may be understood as preserving the speaker's speech features of high signal-to-noise ratio and low distortion.

First of all, the present disclosure designs a high-quality audio segment search module, which may find high-quality audio segments for each sound source (such as a speaker) by analyzing speech features of an input signal, so as to improve the signal-to-noise ratio of separated speech and reduce the distortion of separated speech.

Secondly, the present disclosure designs an adaptive path separation module, which uses a path of adaptively connecting high-quality audio segments for modeling, and extracts and fuses hidden layer state information of the high-quality audio segments to solve the problem of long-term forgetting.

The algorithm presented in the present disclosure may be applied not only to the separation of individual voices from an audio signal including multiple voices, but also to the separation of voices from background noise from an audio signal including both the voices and the background noise, for speech enhancement.

Hereinafter, according to various embodiments of the present disclosure, the methods and devices of the present disclosure are described in detail with reference to the attached drawings.

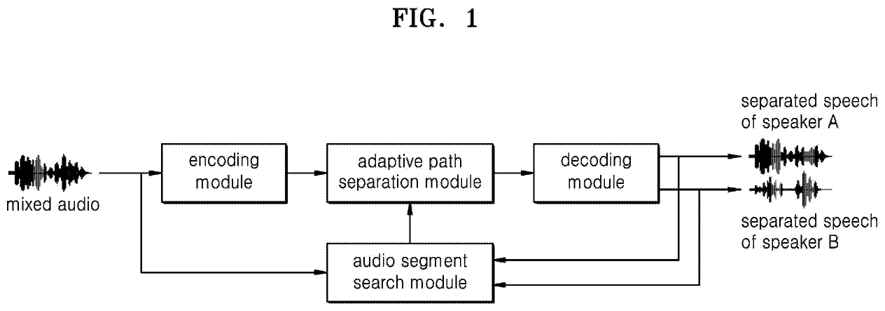

FIG. 1 is a flow diagram of a speech processing method according to an exemplary embodiment of the present disclosure. The speech processing method may be realized through a speech processing model of the present disclosure. The speech processing model includes an encoding module, an audio segment search module, an adaptive path separation module and a decoding module. These modules may be implemented by neural networks.

According to FIG. 1, the encoding module may encode an input audio signal into a high-dimensional feature vector, which may be used to represent speech information of different dimensions.

The audio segment search module may find high-quality audio blocks (each audio block may be composed of multiple audio segments, and one audio segment may be composed of multiple base units. For example, a time length of each audio block is about 8 s, and a time length of each audio segment is about 20 ms) by using speech distortion judgment without reference signals and long-term speech feature analysis. Then, high-quality audio segments are found from the high-quality audio blocks through short-term speech feature analysis, and each sound source (such as a speaker) is operated according to the above method to obtain high-quality audio segment indexes (such as an ID of an audio segment) of each sound source.

The self-adaptive path separation module may perform modeling for the features of the input audio signal (i.e., perform feature separation on the input audio signal) by using a local path and an adaptive path that adaptively connects high-quality audio segments. Among them, the local path (which may be understood as intra-frame modeling) is to perform modeling for features between two adjacent base units/audio units. The adaptive path (also understood as inter-frame modeling, that is, modeling for a current frame using speech features of a reference frame) is based on modeling of network hidden layer state information obtained by fusing a high-quality audio segment with a previous audio segment of a current audio segment, to obtain a mask of each sound source. The problem of long-term forgetting may be solved by using the network hidden layer state information.

The decoding module may use the mask to decode the input audio signal and obtain an audio signal of each sound source, such as separated speeches of the speaker A and the speaker B. The disclosed speech processing model may separate speech signals of two or more persons from a mixed audio signal.

When separating a mixed audio in real time, it may be processed in the above way frame by frame. When a high-quality audio segment of a current audio segment is determined, several audio segments before the current audio segment may be taken as an audio block to find the corresponding high-quality audio segment in the audio block.

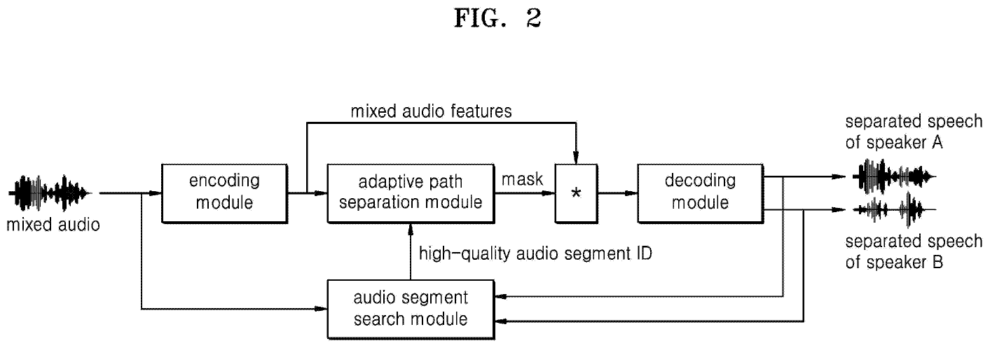

FIG. 2 is a flow diagram of a speech processing method according to another exemplary embodiment of the present disclosure.

According to FIG. 2, an encoding module may perform discrete Fourier transform on an input audio signal and encode a high-dimensional feature vector. An audio segment search module may search for high-quality audio segments of each sound source and output indexes (such as IDs) of the searched high-quality audio segments. An adaptive path separation module may perform local path modeling and adaptive path modeling for the features of the input audio signal, and obtain mask of each sound source. A decoding module may multiply the mask with the feature vector of the input audio signal, and decode the product of the multiplication to obtain an audio signal of each sound source, such as the separated speech of the speaker A and the speaker B.

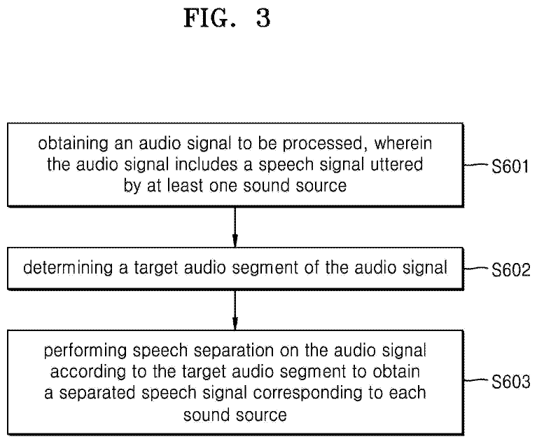

FIG. 3 is a flow chart of a speech processing method according to an exemplary embodiment of the present disclosure. The disclosed speech processing method may be performed on an electronic device with speech processing capabilities. The electronic device may be devices such as a smart phone, a tablet, a laptop and a desktop computer.

With reference to FIG. 3, in step S601, an audio signal to be processed is obtained. The audio signal may include a speech signal uttered by at least one sound source. For example, in an intelligent meeting with multiple participants, when the speech of each participant needs to be separated, an audio signal recorded during the meeting may be used as the audio signal to be processed. For example, when a user wants to separate a speaker's speech from an audio signal containing background music, the audio signal may be the audio signal to be processed. The above examples are illustrative only and the present disclosure is not limited thereto.

In step S602, a target audio segment in the audio signal is determined. The target audio segment may be determined based on speech quality of individual audio segments divided from the audio signal. In the present disclosure, the target audio segment may also be referred to as a high-quality audio segment, and one audio segment may be interpreted as a frame of an audio signal.

The target audio segment is an audio segment with high speech quality that at least one of speech distortion, signal-to-noise ratio, zero-crossing rate, and pitch quantity meets a predefined condition. In the present disclosure, the separation module may be realized based on hidden layer state information obtained through adaptive connection of high-quality audio segments. If the separation effect is good, it indicates that the hidden layer state information may well express features of each sound source, which means that the separation effect may be used to evaluate whether the hidden layer state information may well express the features of the speech signal. Therefore, high-quality audio segments in the original audio signal may be determined for each audio block.

Considering the characteristics of long-term relative stability and short-term instability of audio signals, both need to be taken into account. Therefore, the evaluation of speech quality in the present disclosure is performed on two scales of long-term and short-term. The audio signal may be divided into audio blocks (e.g., one audio block is 8 s) according to a first time period and each audio block may be divided into audio segments (e.g., one audio segment is 20 ms) according to a second time period.

As an example, for each audio block, a high-quality audio segment for a current audio block may be determined based on the audio quality of the individual audio segments in that audio block. The high-quality audio segment for the current audio block may be used for feature separation of the current audio block or a next audio block.

As another example, for each sound source that has been separated, a high-quality audio segment for each sound source in the original audio signal is determined for each audio block. The high-quality audio segments for the current audio block may be used for feature separation of a next audio block. In other words, the high-quality audio segment determined at the present moment may be used for feature separation at the next moment.

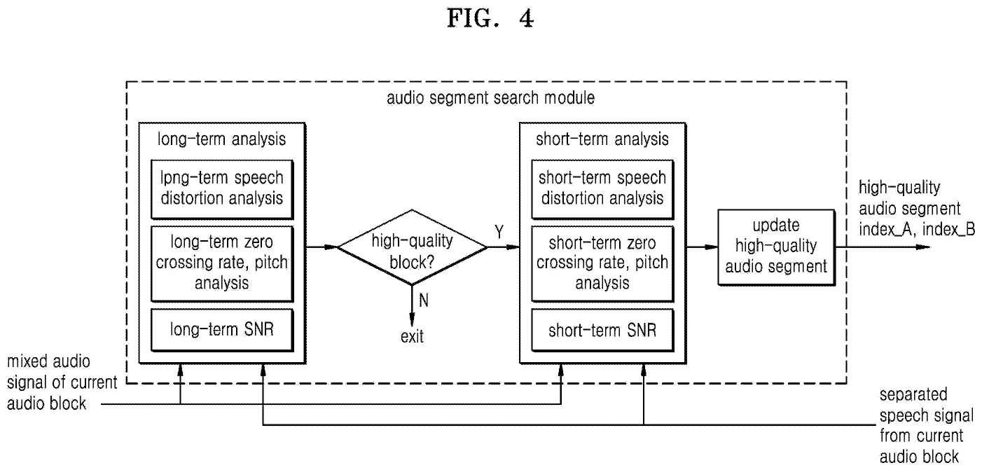

FIG. 4 shows a schematic diagram of searching for a high-quality audio segment according to an exemplary embodiment of the present disclosure. FIG. 4 illustrates the search for a high-quality audio segment in a current audio block as an example. In the present disclosure, a high-quality audio segment determined for a previous audio block is used in the speech separation of a current audio block. That is, the step to determine whether an audio block is a high-quality audio block is performed after separating speech signals of individual sound sources from that audio block.

With reference to FIG. 4, for each sound source that has been separated in the audio signal, whether the current audio block belongs to a target audio block is determined based on speech quality of the current audio block. Here, the speech quality may include at least one of speech distortion, signal-to-noise ratio (SNR), zero crossing rate and pitch quantity. For example, if the speech distortion of an audio segment is greater than a preset threshold, the audio segment may be considered as a high-quality audio segment. If the signal-to-noise ratio of an audio segment is less than a preset threshold, the audio segment may be considered as a high-quality audio segment. If the zero crossing rate of an audio segment is greater than a preset threshold, the audio segment may be considered as a high-quality audio segment, and if the pitch quantity in an audio segment is greater than a preset threshold, the audio segment may be considered to be a high-quality audio segment.

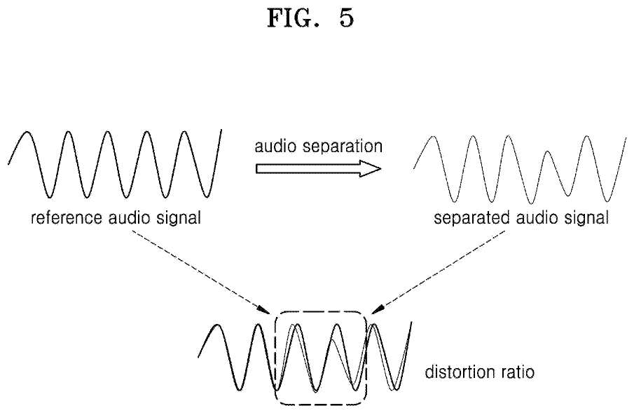

Traditional methods to calculate speech distortion need to use an original pure speech signal as a reference signal. By calculating correlation between a separated speech signal after audio processing and the original reference signal, the distortion of the processed speech signal may be obtained, as shown in FIG. 5.

However, in speech separation, because the input signal is a mixed audio signal, an ideal reference signal may not be obtained, so the present disclosure presents a speech distortion calculation method without the reference signal. For each audio block, the speech distortion may be determined by calculating correlation between the separated speech signal for the current audio block and a reference audio signal (that is, to subtract the separated speech signal from an audio signal obtained by the original audio signal for the corresponding time period).

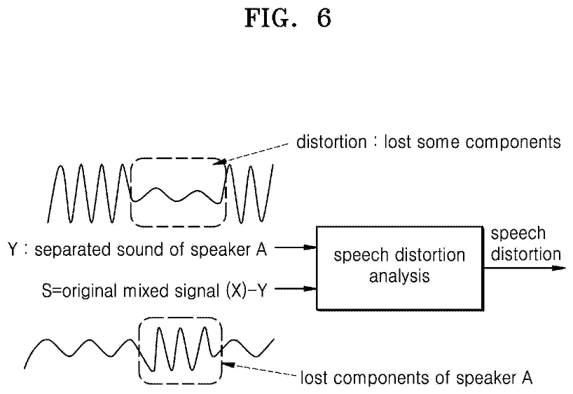

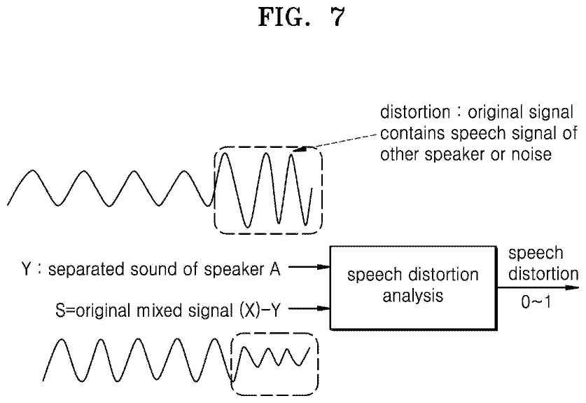

FIGS. 6 and 7 show schematic diagrams of calculating speech distortion according to the present disclosure.

With reference to FIG. 6 and FIG. 7, a speech signal (represented by Y) of a speaker A separated from a current audio block and an audio signal (represented by S) obtained by subtracting the separated speech signal of the speaker A from an original audio signal corresponding to the current audio block are used to determine distortion of the speech signal S by comparing correlation between the speech signal Y and the audio signal S. If the correlation is strong, it indicates that there is a component related to the speaker A in the audio signal S, that is, the separated speech signal Y has lost some characteristic information of the speaker A. As shown in FIG. 6, subtraction distortion appears in the separated speech signal of the speaker A. As shown in FIG. 7, addition distortion appears in the separated speech signal of the speaker A. Although FIGS. 6 and 7 show the speech signal of the speaker A, separated speech signals from other sound sources may also be used.

In addition, the speech distortion may be achieved using a timing processing network such as LSTM, which may be used to compare the correlation between the speech signal Y and the audio signal S.

In the present disclosure, the speech signal-to-noise ratio may be determined by calculating a ratio between a separated speech signal for the current audio block and an original audio signal of the corresponding time period. For example, for each audio block, the ratio of the separated audio to the original audio may be calculated to determine if there is any redundant component in the current audio block.

In addition, considering that the audio block with good separation effect may not contain the features of the sound source (such as the speaker remaining silent during this time period), the separation effect may be measured by incorporating methods such as pitch detection. For example, for each audio block, whether the current audio block contains a vowel may be determined by analyzing the zero crossing rate of the current audio block and whether the current audio block contains a pitch (that is, the number of pitches). Since vowels are an important part of speech signals, the speech components in the current audio block may be analyzed based on this.

For example, when the speech distortion and the signal-to-noise ratio of the current audio block meet the preset conditions and contain vowels, the current audio block may be determined as a high-quality audio block, and then short-term signal analysis may be carried out.

If the current audio block is a high-quality audio block, it may be determined whether the speech quality of a current audio segment in the current audio block is higher than that of a previous audio segment of the current audio block. If the speech quality of the current audio segment is higher than that of the previous audio segment, it may be determined that whether the speech quality of the current audio segment is higher than that of a target audio segment determined for a previous audio block. Based on the comparison result, the target audio segment corresponding to each sound source is determined for the current audio block.

For each audio segment in a high-quality audio block, the speech distortion of the current audio segment may be determined by calculating the correlation between the separated speech signal for the current audio segment and an audio signal obtained by subtracting the separated speech signal from an original audio signal for the corresponding time period. The SNR of the current audio segment may be determined by calculating the ratio between the separated speech signal for the current audio segment and the original audio signal for the corresponding time period. Whether there is a vowel in the current audio segment may be determined by analyzing the zero crossing rate of the current audio segment and whether there is a pitch. Based on the above calculation, whether the speech quality of the current audio segment is higher than that of the previous audio segment is determined. The calculation of short-term speech distortion, short-term signal-to-noise ratio and short-term pitch analysis is similar to the above long-term calculation method. Here, the audio signal of an audio segment is selected for calculation.

For example, if the speech distortion and the signal-to-noise ratio of the current audio segment are better than those of the previous audio segment, the speech quality of the current audio segment is higher than that of the previous audio segment. Next, the current audio segment is compared with the high-quality audio segment determined for the previous audio block to find the high-quality audio segment suitable for the current audio segment. Here, the high-quality audio segment determined for the previous audio block refers to a high-quality audio segment determined when searching for the high-quality audio segment for the previous audio block, which may or may not be the audio segment from the previous audio block.

In a case where the speech quality of the current audio segment is higher than that of the target audio segment determined for the previous audio block, the current audio segment may be determined as the target audio segment, that is, the high-quality audio segment is used for the next audio block.

In a case where the speech quality of the current audio segment is lower than that of the target audio segment determined for the previous audio block, if a difference between the speech quality of the current audio segment and that of the target audio segment determined for the previous audio block is less than a preset threshold and a time interval between the current audio segment and the target audio segment determined for the previous audio block is greater than a time threshold, the current audio segment may be determined as the target audio segment, that is, the high-quality audio segment is used for the next audio block.

If any one of the above conditions is not met, the previously determined high-quality audio segment remains unchanged, that is, when the current audio block is separated, the high-quality audio segment determined for the previous audio block is used.

According to another example of the present disclosure, if the current audio block belongs to the target audio block, the speech quality of each audio segment in the current audio block may be determined and a first audio segment with the highest speech quality may be selected from the audio segments. Then it is determined whether the speech quality of the first audio segment is higher than that of the target audio segment determined for the previous audio block of the current audio block, and the target audio segment corresponding to each sound source for the current audio block is determined based on the comparison result. For example, if the speech quality of the first audio segment is higher than that of the target audio segment determined for the previous audio block, the first audio segment may be determined as the target audio segment; if the speech quality of the first audio segment is lower than that of the target audio segment determined for the previous audio block, and if the difference between the speech quality of the first audio segment and that of the target audio segment determined for the previous audio block is less than the preset threshold and the time interval between the first audio segment and the target audio segment determined for the previous audio block is greater than the time threshold, the current audio segment is determined as the target audio segment.

If the current audio block does not belong to the high-quality audio block, the search for the high-quality audio segment may be ended, that is, the previously determined high-quality audio segment is continually used.

After the high-quality audio segment is determined for the current audio block, the high-quality audio segment index for each sound source may be output. In this way, the separation module of the present disclosure may use the high-quality audio segment index determined for the current audio block to find the corresponding audio segment when the next audio block is separated.

In step S603, speech separation is performed on the audio signal based on the target audio segment to obtain a separated speech signal corresponding to each sound source.

In order for modeling for the audio signal and use the neural network to learn inherent connection between the audio signals, the feature extraction of the audio signal may be carried out first to obtain high-dimensional speech feature information. The audio signal may be encoded to obtain encoding features of the audio signal. For example, the audio signal may be transformed by discrete Fourier transform and encoded into a high-dimensional feature vector, which may be used to represent speech information of different dimensions. Here, the encoding may be performed by the encoding module of the speech processing model of the present disclosure.

As an example, the encoding module may be used to extract the features of the audio signal and obtain a feature vector of another dimension, which is helpful to the modeling and learning of the audio signal by the neural network. Short-Time Fourier Transform (STFT) may be used for feature extraction. For example, the encoding module may use STFT to perform frame splitting and Fourier transform on an audio signal s1, to obtain speech features in the frequency domain. For an audio signal with a sampling rate of 16K Hz and a duration of n seconds, there are sampling points L=n*16000. After performing the STFT of s_n points, that is, the number of sampling points per frame is s_n, an overlap area between frames is s_n/2 (i.e., 50% overlap rate), and the number of frames M=L/(s_n/2)-1, and the number of frequency points per frame f-s_n/2. The real and imaginary parts of the frequency domain are taken out respectively, then the dimension of the output feature vector is [M, f]. In the following description, an audio signal with a sampling rate of 16K Hz and a duration of 8 s is used as an example.

When STFT of 512 sampling points per frame is performed on a speech signal with a duration of 8 s and a sampling rate of 16K Hz, the number of the frequency points per frame may be obtained, i.e., s_n/2=512/2=256, and a feature vector with a dimension of [499,256] may be obtained, that is, there are 499 frames, each frame has 256 frequency points. Each frequency point is represented by a real part and an imaginary part.

In addition, other feature extraction methods (such as a convolutional neural network (CNN)) may also be used for feature extraction, and the present disclosure is not limited thereto.

After feature extraction in the previous step, the encoding module may directly use an encoder to encode and obtain a feature vector of a higher dimension. It may also divide the extracted features to obtain sub-features, and then encode the sub-features by using respective encoders, so as to reduce the complexity of the neural network and improve the processing speed of the neural network.

As an example, a subband-based encoding method may be adopted when the extracted features are divided according to frequency bands. For example, a frequency band of 16K Hz is divided into N subbands, and N subband features are obtained accordingly. N sub-encoders are used for encoding respectively.

The more subbands are divided, the finer the feature processing will be, but more sub-encoders will be introduced, which would improve the network complexity. Considering the performance and network complexity, the extracted features may be divided into 4 to 6 subband features, and 4 to 6 sub-encoders are used accordingly.

For example, by adopting a division mode of 4 subbands, according to the frequency domain data obtained by feature extraction, the data fₖ with 256 frequency points in each frame is divided into four subband features of f1ₖ, f2ₖ, f3ₖ and f4ₖ. The frequency points contained in each subband feature are {1˜32}, {33˜64}, {65˜128}, and {129˜256}, and the corresponding frequencies are 0˜2K, 2K˜4K, 4K˜8K, and 8K˜16K, where k={0, 1, 2 . . . , 498}, represents the frame number.

If the extracted features are not divided into subband features, the encoding module may use one encoder to encode the full-band features to obtain a higher-dimensional feature vector.

If the subband processing is adopted, the full-band features are divided into multiple subband features, and each subband feature needs to be encoded by different sub-encoders, thereby achieving parallel encoding and reducing complexity. It is assumed that the number of subband divisions is N, there are N sub-encoders corresponding to individual subband features.

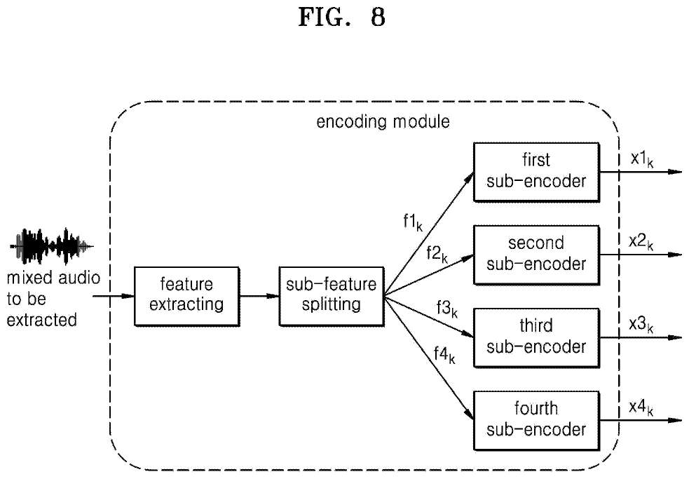

FIG. 8 shows a schematic diagram of a subband-based encoding module according to an exemplary embodiment of the present disclosure.

With reference to FIG. 8, the encoding module may perform feature extraction on an audio signal to be processed to obtain the extracted features, and perform subband feature division on the extracted features (i.e., full-band features) to obtain multiple subband features. In FIG. 8, there are 4 sub-encoders in the encoding module, and accordingly 4 subband features are obtained when performing subband feature division. Each sub-encoder may process the corresponding subband feature to encode the same into a higher-dimensional feature vector. Each sub-encoder may be implemented by a 2-D convolutional network.

In the encoding process, the first sub-encoder may extend the dimension [499,64] of the subband feature f1ₖ (here, it represents the subband feature with frequency points {1˜32} of 499 frames from 0 to 498) to [1,1,499,64], perform 2-dimensional convolution operation, in which the output channel of the convolutional network is 256, the convolution kernel is 5×5, and the step size is 1×1, and output the subband encoded feature vector x1ₖ [1,256,499,64]. The second sub-encoder may extend the dimension [499,64] of the subband feature f2ₖ (here, it represents the subband feature with frequency points {33˜64} of 499 frames from 0 to 498) to [1,1,499,64], perform 2-dimensional convolution operation, in which the output channel of the convolutional network is 256, the convolution kernel is 5×5, and the step size is 1×1, and output the subband encoded feature vector x2ₖ [1,256,499,64]. The third sub-encoder may extend the dimension [499,128] of the subband feature f3ₖ (here, it represents the subband feature with frequency points {65˜128} of 499 frames from 0 to 498) to [1,1,499,128], perform 2-dimensional convolution operation, in which the output channel of the convolutional network is 256, the convolution kernel is 5×6, and the step size is 1×2, and output the subband encoded feature vector x3ₖ [1,256,499,64]. The fourth sub-encoder extends the dimension [499,256] of the subband feature f4ₖ (here, it represents the subband feature with frequency points {129˜256} of 499 frames from 0 to 498) to [1,1,499,256], performs 2-dimensional convolution operation, in which the output channel of the convolutional network is 256, the convolution kernel is 5×6, and the step size is 1×4, and outputs the subband encoded feature vector x4ₖ [1,256,499,64]. The above examples are illustrative only and the present disclosure is not limited thereto.

After being processed by the encoders, the dimension of each subband feature vector xiₖ is [1,256,499,64], where i represents the ith band and k represents the kth frame.

Next, feature separation may be performed on the encoded features of the audio signal based on the determined target audio segment to obtain a feature mask corresponding to each sound source.

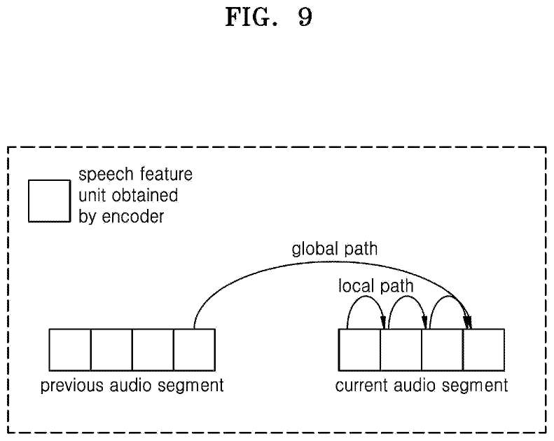

A modeling path may adopt a fixed path modeling method combining a local path and a global path, as shown in FIG. 9. The features of a speaker are delivered by iterating hidden layer state information. However, when the speaker remains silent for a long time, both long-term and short-term feature information of the speaker obtained by iteration may be gradually lost, causing the problem of separation error.

Based on this, the present disclosure introduces a fusion procedure of hidden layer state information of the network (the neural network for feature separation) to solve the problem of gradually losing the speech feature information of the speaker when the speaker does not speak for a long time. The present disclosure fuses the hidden layer state information of the high-quality audio segment of each sound source searched by the audio segment search module into the current hidden layer state, so that the network may retain the speech features of each sound source, so as to solve the problem of long-term network forgetting. At the same time, the hidden layer state information of the previous audio segment may be fused to make the network better track the context information and short-term feature information, so as to ensure the continuity of the hidden layer state.

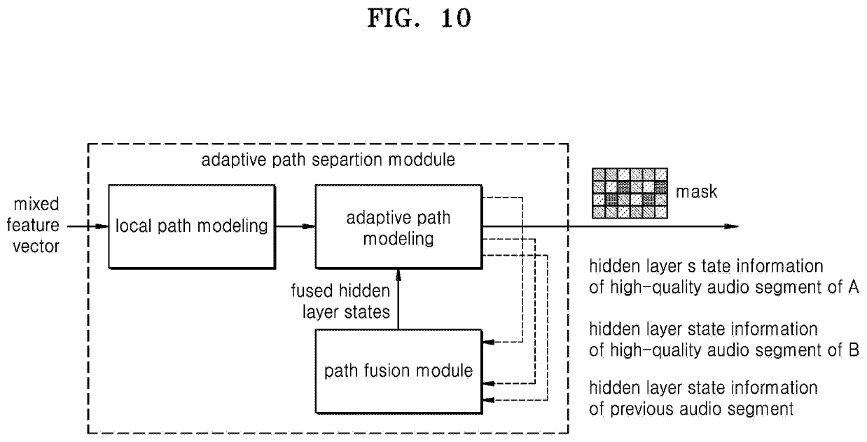

FIG. 10 shows a schematic diagram of feature separation according to an exemplary embodiment of the present disclosure. Feature separation of an audio signal may be performed by an adaptive path separation module of the present disclosure, which may be realized by a neural network. For example, the separation module may adopt a recursive neural network as the main framework, or other neural networks with timing processing capability (such as a convolutional neural network).

With reference to FIG. 10, local path modeling may be carried out on encoded features of the audio signal first, and then adaptive path modeling may be carried out on the features obtained through the local path modeling to obtain a feature mask representing each sound source. In this case, the local path modeling and the adaptive path modeling may be realized by different neural networks. For example, a first LSTM may be used for the local path modeling and a second LSTM may be used for the adaptive path modeling. In the adaptive path modeling, feature separation may be performed on the current audio segment by fusing the hidden layer state information obtained when performing feature separation on the previous audio segment (such as the hidden layer state information of the high-quality audio segment of sound sources A and B and the hidden layer state information of the previous audio segment).

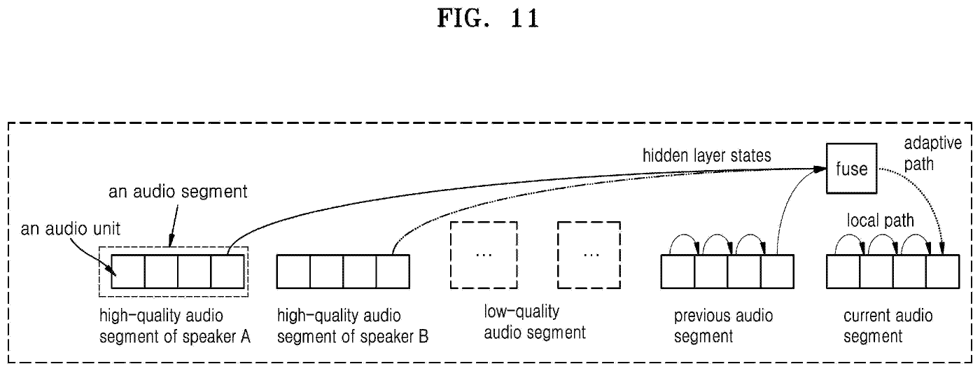

FIG. 11 shows a schematic diagram of fusing hidden layer state information according to an exemplary embodiment of the present disclosure.

When performing feature separation on the current audio segment, local path modeling may be performed on the current audio segment first, in which feature separation may be performed by unit for each audio unit of the current audio segment. Then, adaptive path modeling may be performed on the current audio segment, in which the hidden layer state information of the searched high-quality audio segment is fused with the hidden layer state information of the previous audio segment, and feature separation is performed on the current audio segment by using the fused hidden layer state information. In the adaptive path modeling, when feature separation is performed on an audio unit of the current audio segment, the hidden layer state information of the collocated audio units of the high-quality audio segment and the previous audio segment may be used. Here, the audio unit may refer to a feature unit in an audio segment obtained by splitting and rearranging the original encoded features. The audio unit in the local path modeling may be different from that in the adaptive path modeling.

With reference to FIG. 11, it is assumed that the feature separation is performed according to audio blocks. After obtaining the high-quality audio segment determined for the previous audio block, the corresponding hidden layer state information may be found according to the high-quality audio segment. And the hidden layer state information of the high-quality audio segment (such as the hidden layer state information of the high-quality audio segment of the speaker A and B) is fused with the hidden layer state information of the previous audio segment to obtain the fused hidden layer state information for the adaptive path modeling of the current audio block.

The fusion method of hidden layer state information may be realized by using a method of weighting. Taking the audio signal including two speakers as an example, the following equation may be used for the fusion of the hidden layer state information.

h_{fusion}=α_{q}*(h_{A}+h_{B})+γₛ₋₁*hₛ₋₁

Where, h_{A} and h_{B} respectively represent the hidden layer state information of the speakers A and B, hₛ₋₁ represents the hidden layer state information of the previous audio segment, α_{q} represents the weight of the hidden layer state information of the speakers A and B, and γₛ₋₁ represents the weight of the hidden layer state information of the previous audio segment. Here, since the speakers A and B are equally important, the same weight α_{q} is used, and different weights may be set according to the importance of the speakers. In addition, since the weight γₛ₋₁ of the hidden layer state information of the previous audio segment is related to the speech quality of the high-quality audio segment, if the high-quality audio segment is updated for the current audio block, the hidden layer state information of the previous audio segment may use a smaller weight, and if the high-quality audio segment is not updated for the current audio block, the hidden layer state information of the previous audio segment may use a larger weight, so that the network may obtain more contextual information and short-term features. The weights of each hidden layer state information may be set differently.

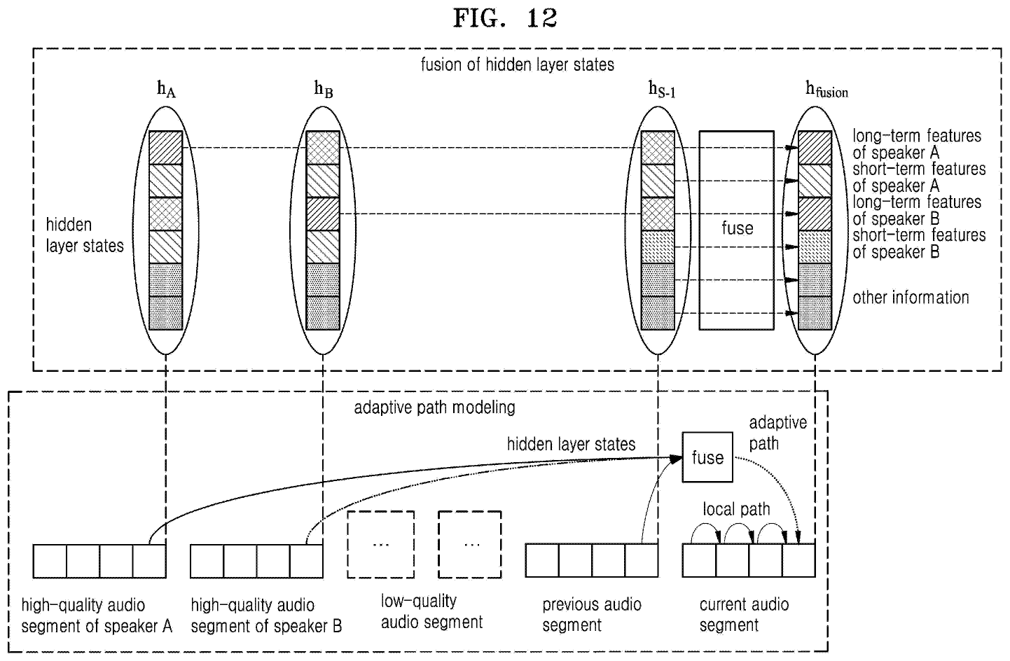

In addition, timing processing networks such as LSTM may be used to fuse the hidden layer state information. The timing processing network may learn how to fuse the hidden layer state information to achieve the best separation effect, as shown in FIG. 12.

FIG. 12 shows a schematic flowchart of fusing hidden layer state information by using a timing processing network according to an exemplary embodiment of the present disclosure.

With reference to FIG. 12 and taking an audio signal including speech signals of two speakers as an example, hidden layer state information h_{A} and h_{B} of speakers A and B and hidden layer state information hₛ₋₁ of a previous audio segment are fused through LSTM to output fused hidden layer state information. It includes long-term and short-time features of the speaker A, long-term and short-time features of the speaker B and other feature information. The short-time features include pitch, timbre and other speech features. The long-term features include rhythm, pronunciation habit, intonation and other speech features. The other information may include context information and environment information, and the state information is independent of the features of the speakers in the separation module.

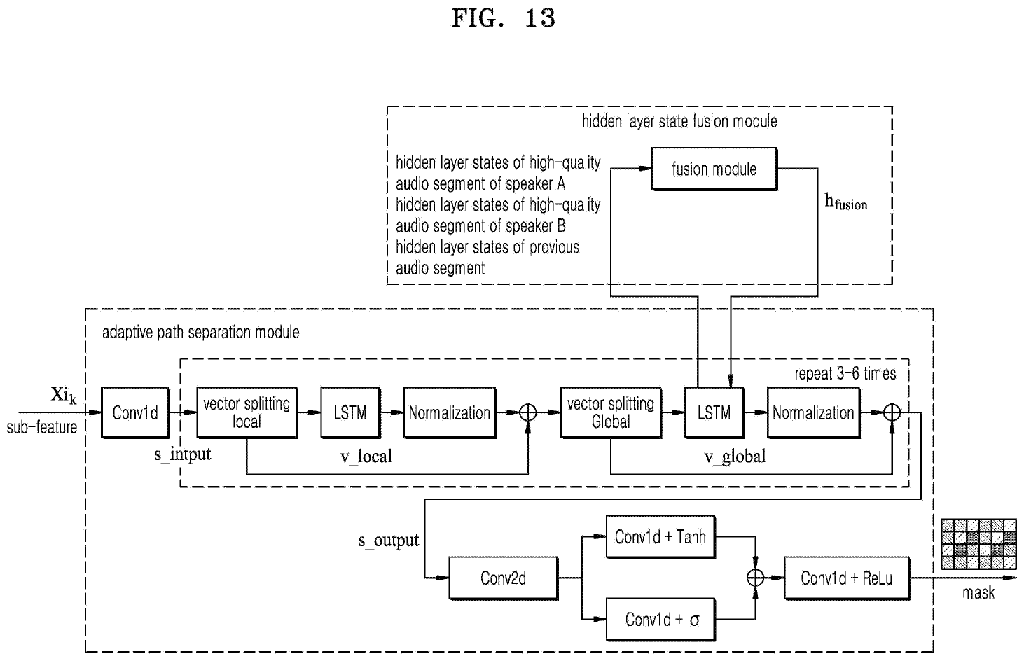

FIG. 13 shows a schematic diagram of a process for feature separation according to an exemplary embodiment of the present disclosure.

As shown in FIG. 13, in order to reduce the complexity of the neural network during feature separation, dimension reduction of an input feature vector may be carried out first. For example, in the case of subband processing, for each subband encoded feature vector xiₖ (its dimension is [256,499×64], where 256 represents the number of channels, 499 represents the number of frames, and 64 represents the number of frequency points), a 1-dimensional convolution operation (Conv1d) may be performed on xiₖ to obtain a new feature vector s_intput [64, 499×64], i.e., the feature dimension is reduced from 256 to 64.

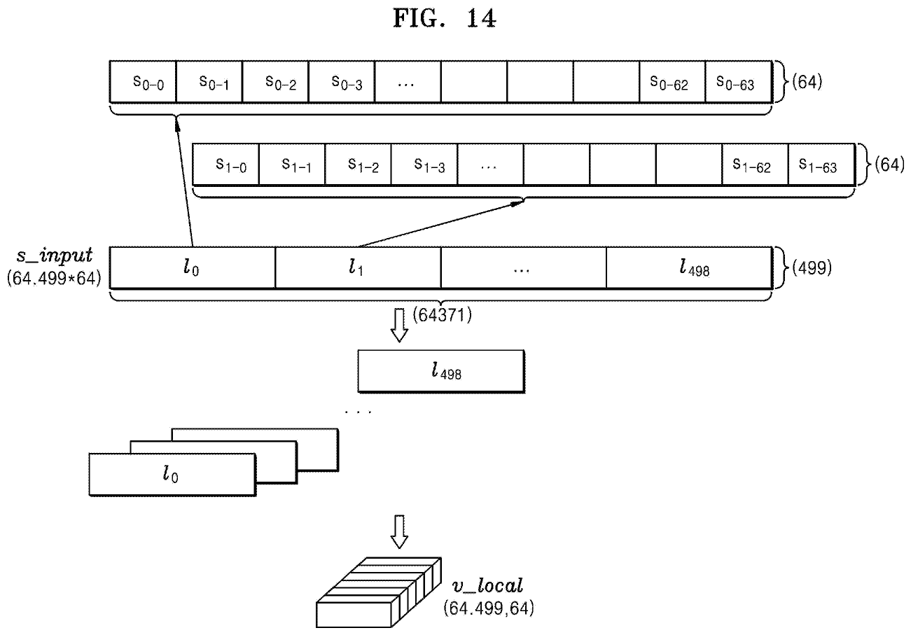

In the local path modeling, the input feature vector s_intput may be split and rearranged to obtain transverse local features (representing all features on a frame). The corresponding vector splitting mode may be defined as a local splitting mode. The operation of the local splitting mode is as follows: the feature vector s_intput after dimension reduction is split by frame, and then rearranged into a 3D feature vector. As shown in FIG. 14, l₀, l₁, . . . , l₄₉₈ respectively represent the characteristic data of frame 0, frame 1, . . . , frame 498. Each frame contains 64 frequency features. For example, l₀ contains 64 frequency features of frame 0 {s₀₋₀, s₀₋₁, s₀₋₂ . . . s₀₋₆₃}. A 3D feature vector v_local [64,499,64] may be obtained by splitting and rearranging 499 frames of data.

Feature separation is performed on the feature vector v_local by the first LSTM, and a first feature vector is output through a Normalization layer. In the present disclosure, the first feature vector may be understood as a feature vector obtained by the local path modeling. In the local path modeling, the hidden layer states of the LSTM for modeling the feature vector v_local are iterated inside the LSTM to obtain the latest context information and short-term features.

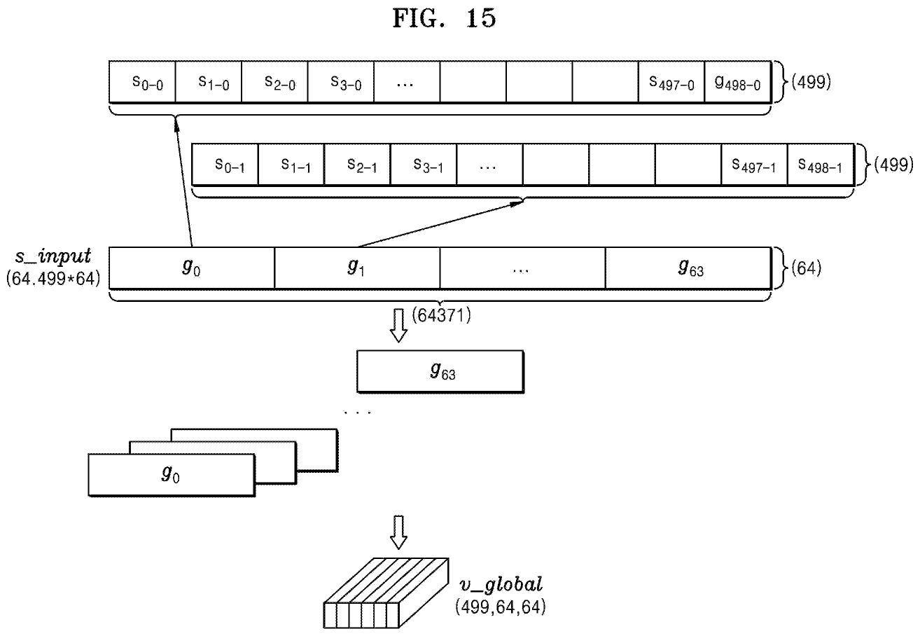

In order for better modeling with respect to the first feature vector obtained from the local path modeling, in the adaptive path modeling, it may be split and rearranged again to obtain longitudinal global features (representing features of a certain frequency point on all frames). The corresponding vector splitting mode may be defined as a global splitting mode. The operation of the global splitting mode is as follows: the first feature vector is split by the unit of frame, and then rearranged into another 3D feature vector. As shown in FIG. 15, it is split into 64 blocks of feature data g₀, g₁, . . . , g₆₃, each block of feature data contains features of a specific frequency of each frame. For example, g₀ contains the zeroth frequency features in 499 frames of data {s₀₋₀, s₁₋₀, s₂₋₀ . . . s₄₉₈₋₀}. A 3D feature vector v_global [499,64,64] is obtained by splitting and rearranging 499 frames of data.

Feature separation is performed on the feature vector v_global by the second LSTM, and a separated feature vector s_output is output through a Normalization layer.

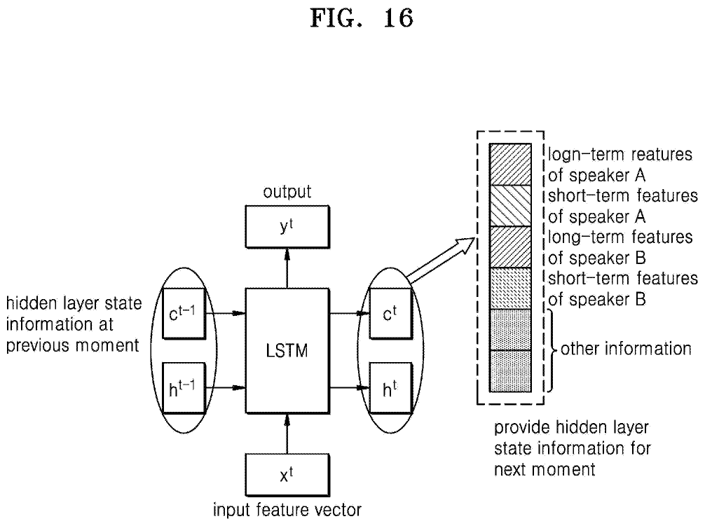

FIG. 16 shows a schematic diagram of performing feature separation on a feature vector v_global by a second LSTM according to an exemplary embodiment of the present disclosure.

With reference to FIG. 16, the second LSTM uses fused hidden layer state information of a previous moment (c^{t-1}, h^{t-1}) to perform feature separation on a feature vector xₜ at a current moment (i.e., v_global at the current moment). The separated speech feature yₜ and the hidden layer state information (c^{t}, h^{t}) obtained during feature separation of the feature vector xₜ at the current moment are output to be used for feature separation of the feature vector v_global at a next moment.

When modeling for the feature vector v_global, the hidden layer states of the second LSTM may be initialized with the obtained fused hidden layer state information h_{fusion}. By processing the data of each frame, the hidden layer states of the second LSTM may be constantly updated. The hidden layer states contain the high-quality speech features of each sound source.

In addition to the LSTM network, the present disclosure may also use CNN, Transformer and other networks for feature separation.

Next, the output feature vector s_output passes through a two-dimensional convolution layer (Conv2d), a one-dimensional convolution layer and a Tanh activation layer (Conv1d+Tanh), a one-dimensional convolution layer and a sigmoid activation layer (Conv1d+σ), and the two outputs are multiplied to obtain a feature vector [m,64,499,64]. Finally, a one-dimensional convolution layer and an activation function (Conv1d+ReLu) is used to perform dimension recovery and finally a mask for each sound source [m,256,499,64] is output, where m represents the number of sound sources to be separated, 256 represents the feature dimension of each frequency component, 499 represents the number of frames, and 64 represents the number of frequency components. For example, m=2, which indicates the speaker A and the speaker B respectively.

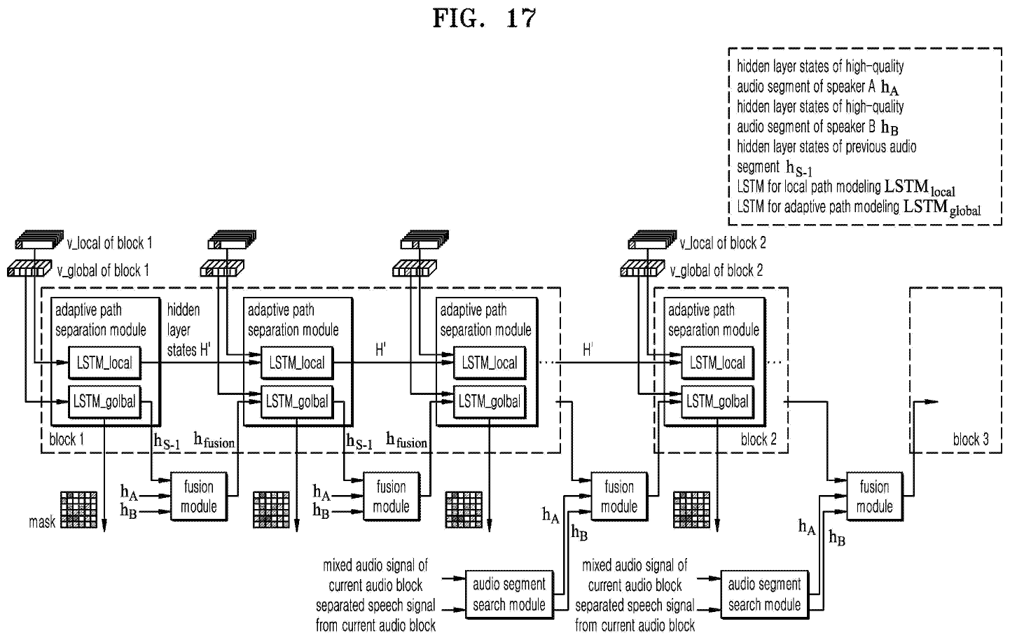

FIG. 17 shows a schematic diagram of performing feature separation by an adaptive path separation module according to an exemplary embodiment of the present disclosure. The following describes feature separation of an audio block as an example.

With reference to FIG. 17, after obtaining encoding features of an audio signal through the encoding module, the encoding features may be divided into multiple audio blocks. For each audio block, each frame contained in the audio block may be split and rearranged according to the local splitting mode as shown in FIG. 14 to obtain a 3D feature vector v_local, which may pass through the first LSTM (LSTM_local) to obtain a first feature vector, and the first feature vector may be split and rearranged according to the global splitting mode shown in FIG. 15 to obtain another 3D feature vector v_global, which passes through the second LSTM (LSTM global) to output separated features. A high-quality audio segment determined for a previous audio block may be used for feature separation of a current audio block, and the same high-quality audio segment may be used for feature separation of individual audio segments within an audio block. For example, taking an audio signal containing two speakers as an example, hidden layer state information h_{A} and h_{B} of speakers A and B and hidden layer state information hₛ₋₁ of a previous audio segment are fused through LSTM, and the fused hidden layer state information h_{fusion} is output.

In FIG. 17, the first LSTM and the second LSTM perform feature separation frame by frame for each audio block. In the feature separation of each frame, the hidden layer state information of the previous frame and the hidden layer state information of the high-quality audio frame are used for feature separation.

According to another embodiment of the present disclosure, for each audio segment of an audio signal, feature separation may be performed on encoded features corresponding to a current audio segment based on a target audio segment determined for a previous audio block of an audio block where the current audio segment is located and a previous audio segment of the current audio segment, to obtain a feature mask corresponding to each sound source. Because the neural network is used for feature separation, the hidden state information of the network may also express the features of the speech signal. Therefore, the hidden layer state information of the target audio segment and the previous audio segment may be acquired. Here, the hidden layer state information is obtained during feature separation of the target audio segment and the previous audio segment and includes at least one of short-term speech features, long-term speech features and context features of each sound source. Then, the hidden layer state information of the target audio segment and the previous audio segment is fused to obtain fused hidden layer state information, and the encoding features corresponding to the current audio segment is separated based on the fused hidden layer state information. Local path modeling and adaptive path modeling may be used to separate the features of each audio segment.

For example, the encoding features corresponding to the current audio segment may include multiple audio units, intra-frame processing may be performed first, that is, feature separation is performed unit by unit to obtain first separated features corresponding to the current audio segment, and then inter-frame processing is performed, that is, feature separation is performed on the first separated features based on the fused hidden layer state information, to obtain the feature mask for each sound source of the current audio segment.

The above method for feature separation of the audio signal may be applied to the case without frequency band division and also to the case of subband processing.

The audio signal may be decoded based on the feature mask to obtain a separated speech signal corresponding to each sound source. For example, the mask obtained by the separation module and the feature vector of the audio signal output by the encoding module may be dot multiplied, and the feature decoding may be further carried out to recover the separated time domain signals of each sound source.

If the extracted features are not divided into subband features, the decoding module may use one decoder to decode the full-band features to obtain the separated speech signals of each sound source.

If the subband processing is adopted, the decoding module may use different sub-decoders to decode, thereby achieving parallel decoding and reducing complexity. It is assumed that there are N sub-encoders corresponding to individual subband features, there are N sub-decoders to decode each subband feature.

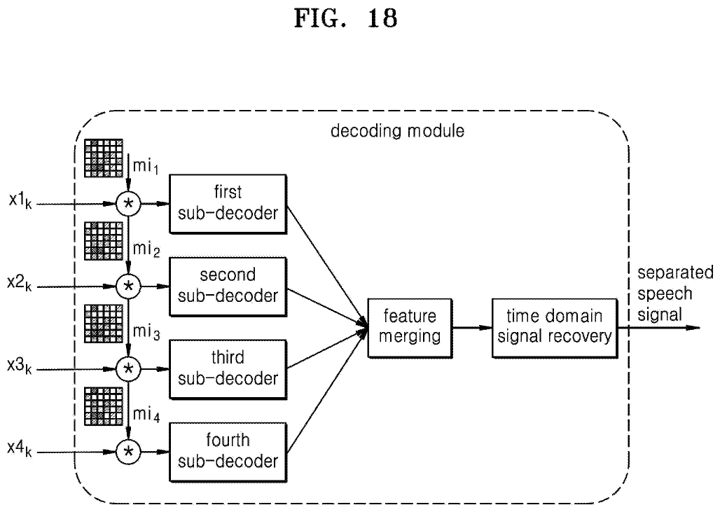

FIG. 18 shows a schematic diagram of a subband-based decoding module according to an exemplary embodiment of the present disclosure.

With reference to FIG. 18, the decoding module may dot multiply the subband mask miₖ predicted by the separation module and the subband encoding feature vector xiₖ output by the sub-encoder with corresponding elements, and then decode the feature yiₖ of each sound source through the subdecoder, where i represents the ith subband and k represents the kth frame. the predicted features yiₖ are combined (band merge) to obtain yₖ, which is convenient for later feature transformation processing. Short-Time Fourier transform (STFT) or other feature transform methods (such as CNN) is used for audio signal recovery. It is assumed that the encoding module adopts short-time Fourier transform for feature extraction, the inverse Fourier transform is performed on the features to obtain the separated speech signals of individual sound sources.

The sub-decoder may be implemented by a linear full connection layer, or it may use other networks (such as CNN) for feature conversion to calculate the predicted features of the target sound source.

The speech separation technology of the present disclosure may be applied to intelligent meeting minutes, audio and video editing, speech calls and other common scenes in life.

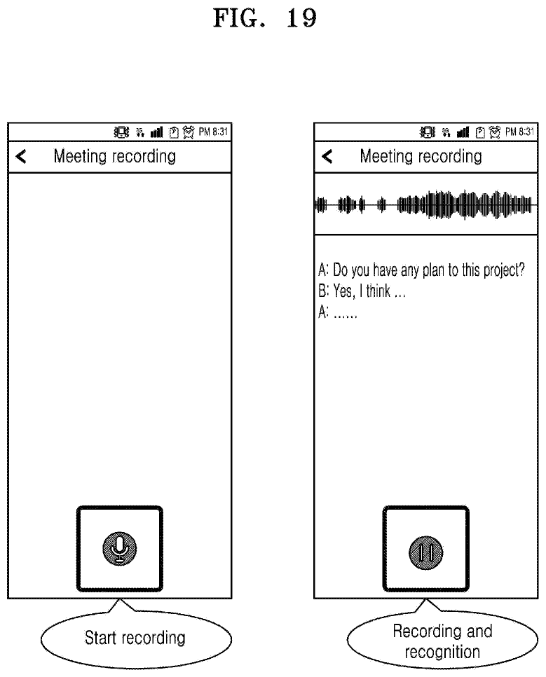

For example, when multiple people are in a meeting, their speeches may be separated in real time and subsequent processing (such as real-time transcription, recognition, translation, etc.) is performed thereon. As shown in FIG. 19, when multiple people participate in an online meeting, the speech of each participant may be separated in real time by using the method of the present disclosure after the participant's speech is recorded. The present disclosure may significantly improve the accuracy of separation, especially when a participant does not speak for a long period of time.

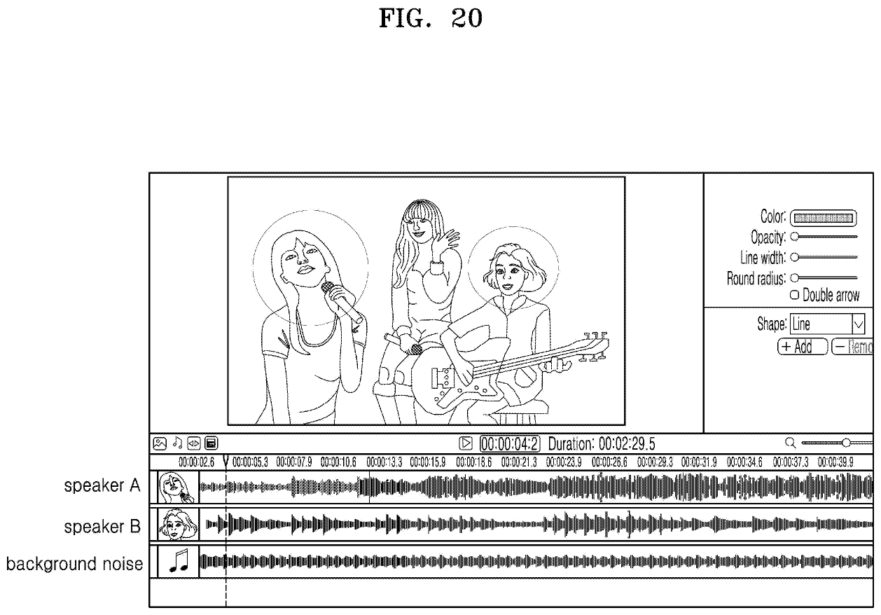

In addition, the speech separation technology proposed in the present disclosure may be applied to video/audio editors in smart phones to edit sounds required by users in video/audio. For example, the speech separation technology of the present disclosure may separate each speaker's speech in video/audio (such as a speaker A, a speaker B, background noise, etc.). As shown in FIG. 20, when speech separation is performed on a video, the method of the present disclosure may separate the speech of each speaker or a certain speaker and background noise in the video. The user may edit the separated sounds. For example, the user may change the speed of a speaker's speech, or beautify a speaker's speech, or delete a speech that the user does not require. The user may process each separated sound to generate a desired sound. The above examples are illustrative only and the present disclosure is not limited to this.

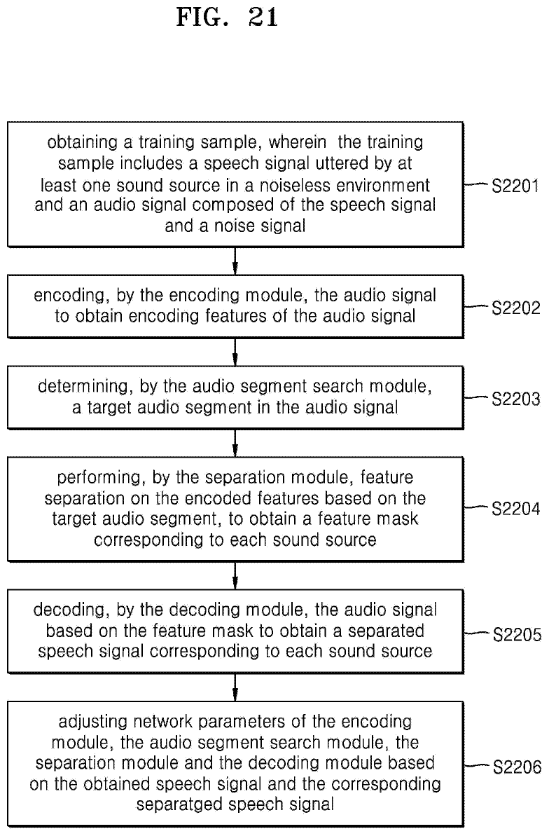

FIG. 21 is a flowchart of a training method for a speech processing model according to an exemplary embodiment of the present disclosure. The speech processing model of the present disclosure may be trained on electronic devices or servers.

The speech processing model of the present disclosure may include an encoding module, an audio segment search module, an adaptive path separation module and a decoding module. The separation module may include a first separation module (also known as a local path modeling module), a hidden layer state information fusion module and a second separation module (also known as an adaptive path modeling module), and each module may be realized by a neural network.

With reference to FIG. 21, in step S2201, a training sample is obtained. The training sample includes a speech signal uttered by at least one sound source in a noiseless environment and an audio signal composed of the speech signal and a noise signal.

In step S2202, the audio signal is encoded by the encoding module to obtain encoding features of the audio signal.

In step S2203, the audio segment search module determines a target audio segment in the audio signal, where the target audio segment may be determined based on speech quality of each audio segment divided from the audio signal. The speech quality may include at least one of speech distortion, signal-to-noise ratio, zero crossing rate, and pitch quantity.

As an example, the audio signal may be divided into multiple audio blocks according to a first time period and each audio block may be divided into multiple audio segments according to a second time period. The target audio segment of the audio signal may be determined for each audio block.

For example, for each audio block, a high-quality audio segment for a current audio block may be determined based on the audio quality of individual audio segments in the audio block. A high-quality audio segment for the current audio block may be used for feature separation of the current audio block or feature separation of the next audio block.

For another example, for each sound source that has been separated, whether a current audio block belongs to a target audio block is determined based on the speech quality of the current audio block. Whether the speech quality of a current audio segment in the current audio block is higher than that of a previous audio segment of the current audio segment is determined in a case where the current audio block belongs to the target audio block. Whether the speech quality of the current audio segment is higher than that of a target audio segment determined for a previous audio block of the current audio block is determined in a case where the speech quality of the current audio segment is higher than that of the previous audio segment. A target audio segment corresponding to each sound source for the current audio block is determined based on the comparison result. For example, the current audio segment is determined as the target audio segment in a case where the speech quality of the current audio segment is higher than that of the target audio segment determined for the previous audio block. The current audio segment is determined as the target audio segment if a difference between the speech quality of the current audio segment and that of the target audio segment determined for the previous audio block is less than a preset threshold and a time interval between the current audio segment and the target audio segment determined for the previous audio block is greater than a time threshold, in a case where the speech quality of the current audio segment is lower than that of the target audio segment determined for the previous audio block.

As another example, the speech quality of each audio segment in the current audio block may be determined in a case where the current audio block belongs to the target audio block, and a first audio segment with the highest speech quality may be selected. Whether the speech quality of the first audio segment is higher than that of a target audio segment determined for a previous audio block of the current audio block is then determined. A target audio segment corresponding to each sound source for the current audio block is determined based on the comparison result. For example, the first audio segment may be determined as the target audio segment in a case where the speech quality of the first audio segment is higher than that of the target audio segment determined for the previous audio block. The first audio segment may be determined as the target audio segment if a difference between the speech quality of the first audio segment and that of the target audio segment determined for the previous audio block is less than a preset threshold and a time interval between the first audio segment and the target audio segment determined for the previous audio block is greater than a time threshold, in a case where the speech quality of the first audio segment is lower than that of the target audio segment determined for the previous audio block.

The speech quality may include at least one of speech distortion, signal-to-noise ratio, zero crossing rate and pitch quantity, where the speech distortion is determined by calculating correlation between a separated speech signal for an audio segment and a reference audio signal, wherein the reference audio signal is an audio signal obtained by subtracting the separated speech signal from an original audio signal corresponding to the audio segment. The signal-to-noise ratio is determined by calculating a ratio between a separated speech signal for an audio segment and an original audio signal corresponding to the audio segment.

In step S2204, the separation module performs feature separation on the encoded features based on the target audio segment, and obtains a feature mask corresponding to each sound source.

Speech separation is performed on the encoded features corresponding to the current audio segment based on the target audio segment determined for the previous audio block of the audio block where the current audio segment is located and the previous audio segment of the current audio segment, to obtain the feature mask corresponding to each sound source. For example, hidden layer state information of the target audio segment and the previous audio segment may be obtained. The hidden layer state information is obtained when the target audio segment and the previous audio segment are performed speech separation by the separation module and includes at least one of short-term speech features, long-term speech features and context features of each sound source. The hidden layer state information of the target audio segment and the previous audio segment is fused to obtain fused hidden layer state information. Speech separation is performed on the encoded features corresponding to the current audio segment based on the fused hidden layer state information.

For example, the encoded features corresponding to the current audio segment include a plurality of audio units. The first separation module performs speech separation for each audio unit, to obtain a first separated features corresponding to the current audio segment; the second separation module performs speech separation on the first separation features based on the fused hidden layer state information, to obtain the feature mask of the current audio segment for each sound source.

In step S2205, the audio signal is decoded by the decoding module based on the feature mask to obtain a separated speech signal corresponding to each sound source.

In step S2206, network parameters of the encoding module, the audio segment search module, the separation module and the decoding module are adjusted based on the obtained speech signal and the corresponding separated speech signal.

For example, a loss function may be configured based on the obtained speech signal (the real signal) and the corresponding separated speech signal (the predicted signal), and the network parameters of each module may be adjusted by minimizing a loss calculated by the loss function.

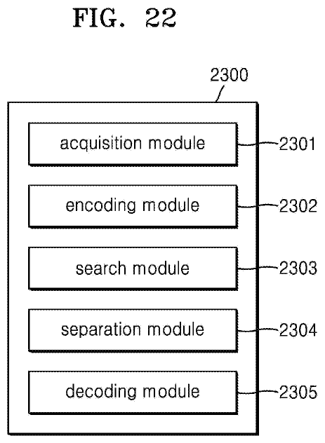

FIG. 22 is a block diagram of a speech processing device according to an exemplary embodiment of the present disclosure.

Referring to FIG. 22, the speech processing device 2300 may include an acquisition module 2301, an encoding module 2302, a search module 2303, a separation module 2304 and a decoding module 2305. Each module in the speech processing device 2300 may be implemented by one or more modules, and the name of the corresponding module may vary according to the type of module. In various embodiments, some modules in the speech processing device 2300 may be omitted or additional modules may be included. Further, the modules/elements according to various embodiments of the present disclosure may be combined to form a single entity, and thus the functions of the respective modules/elements prior to the combination may be equivalently performed.

The acquisition module 2301 may obtain an audio signal to be processed, wherein the audio signal includes a speech signal uttered by at least one sound source.

The encoding module 2302 may encode the audio signal to obtain encoded features of the audio signal.

The search module 2303 may determine a target audio segment of the audio signal, wherein the target audio segment may be determined based on speech quality of each audio segment divided from the audio signal.

The separation module 2304 may perform speech separation on the encoded features according to the target audio segment to obtain a feature mask corresponding to each sound source.

The decoding module 2305 may decode the audio signal based on the feature mask to obtain a separated speech signal corresponding to each sound source.

Alternatively, the search module 2303 may divide the audio signal into a plurality of audio blocks according to a first time period and divide each audio block into a plurality of audio segments according to a second time period, and determine a target audio segment for each audio block with respect to each sound source.

The separation module 2304 may perform speech separation on the encoded features corresponding to a current audio segment based on a target audio segment determined for a previous audio block of an audio block where the current audio segment is located and a previous audio segment of the current audio segment, to obtain the feature mask corresponding to each sound source.

Alternatively, for each sound source that has been separated, the search module 2303 may determine whether a current audio block belongs to a target audio block based on the speech quality of the current audio block, determine whether the speech quality of a current audio segment in the current audio block is higher than that of a previous audio segment of the current audio segment in a case where the current audio block belongs to the target audio block, determine whether the speech quality of the current audio segment is higher than that of a target audio segment determined for a previous audio block of the current audio block in a case where the speech quality of the current audio segment is higher than that of the previous audio segment, and determine a target audio segment corresponding to each sound source for the current audio block based on the comparison result.

Alternatively, the search module 2303 may determine the current audio segment as the target audio segment in a case where the speech quality of the current audio segment is higher than that of the target audio segment determined for the previous audio block, and determine the current audio segment as the target audio segment if a difference between the speech quality of the current audio segment and that of the target audio segment determined for the previous audio block is less than a preset threshold and a time interval between the current audio segment and the target audio segment determined for the previous audio block is greater than a time threshold, in a case where the speech quality of the current audio segment is lower than that of the target audio segment determined for the previous audio block.

Alternatively, for each sound source that has been separated, the search module 2303 may determine whether a current audio block belongs to a target audio block based on the speech quality of the current audio block, determine the speech quality of each audio segment in the current audio block in a case where the current audio block belongs to the target audio block, and select a first audio segment with the highest speech quality, determine whether the speech quality of the first audio segment is higher than that of a target audio segment determined for a previous audio block of the current audio block, and determine a target audio segment corresponding to each sound source for the current audio block based on the comparison result.

Alternatively, the speech quality includes at least one of speech distortion, signal-to-noise ratio, zero crossing rate and pitch quantity.

The speech distortion is determined by calculating correlation between a separated speech signal for an audio segment and a reference audio signal, wherein the reference audio signal is an audio signal obtained by subtracting the separated speech signal from an original audio signal corresponding to the audio segment. The signal-to-noise ratio is determined by calculating a ratio between a separated speech signal for an audio segment and an original audio signal corresponding to the audio segment.

Alternatively, the separation module 2304 may obtain hidden layer state information of the target audio segment and the previous audio segment, wherein the hidden layer state information is obtained when the target audio segment and the previous audio segment are performed speech separation respectively, and includes at least one of short-term speech features, long-term speech features and context features of each sound source. The separation module 2304 may fuse the hidden layer state information of the target audio segment and the previous audio segment to obtain fused hidden layer state information, and perform speech separation on the current audio segment based on the fused hidden layer state information.

Alternatively, the current audio segment includes a plurality of audio units, and the separation module 2304 may perform speech separation for each audio unit, to obtain first separated features corresponding to the current audio segment, and perform speech separation on the first separation features based on the fused hidden layer state information, to obtain the feature mask of the current audio segment for each sound source.

The speech processing process has been described in detail above with respect to FIGS. 1 to 18, and will not be repeated in detail here.

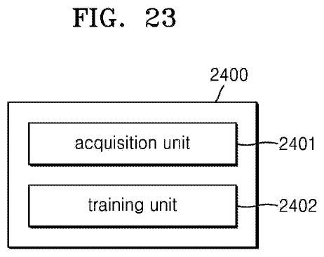

FIG. 23 is a block diagram of a training device for a speech processing model according to an exemplary embodiment of the present disclosure.

Referring to FIG. 23, the training device 2400 may include an acquisition unit 2401 and a training unit 2402. Each module in the training device 2400 may be implemented by one or more modules, and the name of the corresponding module may vary according to the type of module. In various embodiments, some modules in the training device 2400 may be omitted or additional modules may be included. Further, the modules/elements according to various embodiments of the present disclosure may be combined to form a single entity, and thus the functions of the respective modules/elements prior to the combination may be equivalently performed.

The acquisition unit 2401 may obtain a training sample. The training sample includes a speech signal uttered by at least one sound source in a noiseless environment and an audio signal composed of the speech signal and a noise signal.

The training unit 2402 may encode the audio signal by the encoding module to obtain encoding features of the audio signal, determine a target audio segment in the audio signal by the audio segment search module, where the target audio segment includes speech features capable of identifying the corresponding sound source. The training unit 2402 may perform feature separation on the encoded features based on the target audio segment by the separation module and obtain a feature mask corresponding to each sound source, decode the audio signal by the decoding module based on the feature mask to obtain a separated speech signal corresponding to each sound source, and adjust network parameters of the encoding module, the audio segment search module, the separation module and the decoding module based on the obtained speech signal and the corresponding separated speech signal.

The model training process has been described in detail above with respect to FIG. 21, and will not be repeated in detail here.

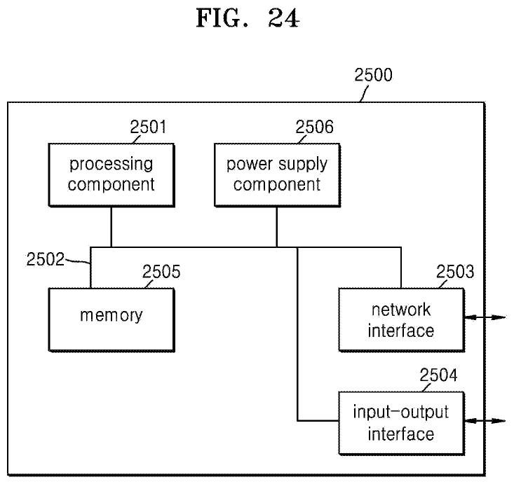

FIG. 24 shows a schematic structural diagram of a speech processing apparatus in hardware operating environment according to an exemplary embodiment of the present disclosure. The speech processing apparatus 2500 may realize the above functions of speech processing and model training.

As shown in FIG. 24, the speech processing apparatus 2500 may include a processing component 2501, a communication bus 2502, a network interface 2503, an input-output interface 2504, a memory 2505 and a power supply component 2506. The communication bus 2502 serves to realize connection communication between these components. The input-output interface 2504 may include a video display (such as a liquid crystal display), a microphone and speaker, and a user interaction interface (such as a keyboard, mouse, touch input device, etc.), and optionally, the input-output interface 2504 may also include a standard wired interface, and a wireless interface. The network interface 2503 may optionally include a standard wired interface and a wireless interface (e.g., a wireless fidelity interface). The memory 2505 may be a high-speed random access memory or a stable non-volatile memory. The memory 2505 may optionally be a storage device independent of the aforementioned processing component 2501.

Those skilled in the art will appreciate that the configuration shown in FIG. 24 does not constitute a limitation to the speech processing apparatus 2500 and may include more or fewer components than illustrated or a combination of certain components or different component arrangements.

As shown in FIG. 24, the memory 2505, as a storage medium, may include an operating system, a data storage module, a network communication module, a user interface module, a program related to the above speech processing and model training and a database.

In the speech processing apparatus 2500 shown in FIG. 24, the network interface 2503 is mainly used for data communication with external apparatuses/terminals. The input-output interface 2504 is mainly used for data interaction with users. The processing component 2501 and the memory 2505 in the speech processing apparatus 2500 may be provided in the speech processing apparatus 2500, and the speech processing apparatus 2500 executes the speech processing method and the model training method provided by the embodiment of the present disclosure by calling programs for achieving the speech processing method and the model training method stored in the memory 2505 and various APIs provided by the operating system through the processing component 2501.

The processing component 2501 may include at least one processor, and the memory 2505 stores a set of computer-executable instructions that, when being executed by the at least one processor, execute the speech processing method and the model training method according to the embodiments of the present disclosure. In addition, the processing component 2501 may execute the speech processing process or the model training process and the like. However, the above examples are only exemplary and the present disclosure is not limited thereto.

As an example, the speech processing apparatus 2500 may be a PC computer, a tablet device, a personal digital assistant, a smart phone, or any other device capable of executing the above instruction set. Here, the speech processing apparatus 2500 does not have to be a single electronic device, but may also be any set of devices or circuits capable of executing the above instructions (or instruction set) individually or jointly. The speech processing apparatus 2500 may also be a part of an integrated control system or system manager, or may be configured as a portable electronic device that interfaces locally or remotely (e.g., via wireless transmission).

In the speech processing apparatus 2500, the processing component 2501 may include a central processing unit (CPU), graphics processing unit (GPU), programmable logic device, special purpose processor system, microcontroller or microprocessor. By way of example and not limitation, the processing component 2501 may also include analog processors, digital processors, microprocessors, multi-core processors, processor arrays, network processors, and the like.

The processing component 2501 may execute instructions or code stored in the memory 2505, which may also store data. Instructions and data may also be sent and received over a network via a network interface 2503, which may employ any known transport protocol.

The memory 2505 may be integrated with the processor, e.g., a RAM or flash memory is arranged within an integrated circuit microprocessor or the like. Additionally, the memory 2505 may include a separate device such as an external disk drive, storage array, or any other storage device that may be used by a database system. The memory and the processor may be operatively coupled, or may communicate with each other, e.g., through I/O ports, network connections, etc., to enable the processor to read files stored in the memory.

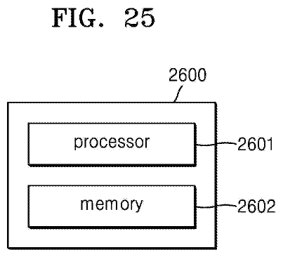

An electronic device may be provided in accordance with the embodiments of the present disclosure. FIG. 25 is a block diagram of an electronic device according to an embodiment of the present disclosure. The electronic device 2600 may include at least one memory 2602 and at least one processor 2601. The at least one memory 2602 stores a set of computer executable instructions that, when executed by the at least one processor 2601, causes the at least one processor 2601 to perform the speech processing method and the model training method according to the embodiments of the present disclosure.

The processor 2601 may include a central processing unit (CPU), an audio and video processor, a programmable logic device, a dedicated processor system, a microcontroller, or a microprocessor. By way of example and not limitation, the processor 2601 may also include analog processors, digital processors, microprocessors, multi-core processors, processor arrays, network processors, and the like.

As a storage medium, the memory 2602 may include an operating system (such as MAC operating system), a data storage module, a network communication module, a user interface module, a recommendation module and database.

The memory 2602 may be integrated with the processor 2601, e.g., a RAM or flash memory is arranged within an integrated circuit microprocessor or the like. Additionally, the memory 2602 may include a separate device such as an external disk drive, storage array, or any other storage device that may be used by a database system. The memory 2602 and the processor 2601 may be operatively coupled, or may communicate with each other, e.g., through I/O ports, network connections, etc., to enable the processor 2601 to read files stored in the memory 2602.

In addition, the electronic device 2600 may also include video displays (e.g. liquid crystal display) and user interaction interfaces (e.g. keyboard, mouse, touch input device, etc.). All components of the electronic device 2600 may be connected to each other via a bus and/or a network.

As an example, the electronic device 2600 may be a PC computer, a tablet device, a personal digital assistant, a smart phone, or any other device capable of executing the above instruction set. Here, the electronic device 2600 does not have to be a single electronic device, but may also be any set of devices or circuits capable of executing the above instructions (or instruction set) individually or jointly. The electronic device 2600 may also be a part of an integrated control system or system manager, or may be configured as a portable electronic device that interfaces locally or remotely (e.g., via wireless transmission).

It is understandable to those skilled in the art that the structure shown in FIG. 25 does not limit the electronic device 2600 and may include more or fewer parts than shown, or combine some parts, or arrange different parts.

At least one of the above multiple modules may be implemented by an AI model. Functions associated with AI may be performed by a non-volatile memory, a volatile memory, and a processor.

The processor may include one or more processors. At this time, one or more processors may be general-purpose processors such as central processing units (CPUs), application processors (APs), etc., processors only used for graphics such as graphics processors (GPUs), vision processors (VPU), and/or AI-specific processors such as neural processing units (NPUs).

One or more processors control processing of inputting data according to predefined operating rules or artificial intelligence (AI) models stored in the non-volatile memory and the volatile memory. The predefined operating rules or the artificial intelligence models may be provided through training or learning. Here, providing by learning means that by applying a learning algorithm to a plurality of learning data, a predefined operating rule or AI model with desired properties is formed. Learning may be performed in an AI executing device itself according to an embodiment, and/or may be implemented by a separate server/device/system.

A learning algorithm is a method of using a plurality of learning data to train a predetermined target device (e.g., a robot) to cause, allow or control the target device to make a determination or prediction. Examples of the learning algorithm include, but are not limited to, supervised learning, unsupervised learning, semi-supervised learning, or reinforcement learning.

According to the present disclosure, in the speech processing method executed by the electronic device, the output speech after processing the target region may be obtained by taking the input speech as the input data of the artificial intelligence model.

An AI model may be obtained by training. Here, “obtained by training” refers to training a basic artificial intelligence model with a plurality of training data through a training algorithm, thereby obtaining a predefined operating rule or artificial intelligence model configured to perform required characteristics (or purposes).

As an example, an artificial intelligence model may include a plurality of neural network layers. Each of the plurality of neural network layers includes a plurality of weight values, and neural network calculation is performed by a calculation between calculation results of a previous layer and the plurality of weight values. Examples of neural networks include, but are not limited to, convolutional neural networks (CNN), deep neural networks (DNN), recurrent neural networks (RNN), restricted boltzmann machines (RBM), deep belief networks (DBN), bidirectional recurrent deep neural networks (BRDNN), generative adversarial networks (GAN), and deep Q-networks.

According to an embodiment of the present disclosure, a computer readable storage medium storing a computer program is also provided. The computer program, when executed by at least one processor, causes the at least one processor to perform the above speech processing method and the model training method according to the exemplary embodiments of the present disclosure. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device. In addition, in one example, the computer programs and any associated data, data files, and data structures are distributed on a networked computer system, so that the computer programs and any associated data, data files, and data structures are stored, accessed and executed through one or more processors or computers in a distributed manner.

A computer program product may also be provided in accordance with the embodiment of the present disclosure. Instructions in the computer program product may be executed by a processor of a computer device to complete the speech processing method and the model training method.

After considering the specification and the practice of the present disclosure, those skilled in the art will readily conceive of other implementations of the present disclosure. This application is intended to cover any variation, use or adaptation of the present disclosure that follows the general principles of the present disclosure and includes the common knowledge or customary technical means in the field of technology not disclosed by the present disclosure. The specification and embodiments are deemed to be exemplary only, and the true scope and spirit of the present disclosure are indicated by the claims below.

It should be understood that the present disclosure is not limited to the precise structure already described above and shown in the attached drawings and is subject to various modifications and changes within its scope. The scope of the present disclosure is limited only by the attached claims.

1. A method performed by an electronic device, comprising:
obtaining an audio signal comprising a speech signal uttered by at least one sound source;
determining a target audio segment of the audio signal, wherein the target audio segment is determined based on a speech quality of at least one audio segment, wherein the at least audio segment is divided from the audio signal; and
performing speech separation on the audio signal based on the target audio segment to obtain at least one separated speech signal corresponding to the at least one sound source.

2. The method of claim 1, wherein the speech quality is identified based on at least one of speech distortion, signal-to-noise ratio, zero crossing rate, and pitch quantity.

3. The method of claim 1, wherein the determining the target audio segment of the audio signal comprises:
dividing the audio signal into a plurality of audio blocks according to a first time period and dividing at least one audio block among the plurality of audio blocks into a plurality of audio segments according to a second time period; and
determining a corresponding target audio segment for a audio block among the plurality of audio blocks;
wherein the performing speech separation on the audio signal comprises:
performing speech separation on a first audio segment from a first audio block, based on a target audio segment determined for a second audio block than the first audio block and a second audio segment of the first audio segment, to obtain the at least one separated speech signal corresponding to the at least one sound source.

4. The method of claim 3, wherein the determining the corresponding target audio segment for the audio block comprises:
for each sound source that has been separated, determining whether the first audio block belongs to a target audio block based on the speech quality of the first audio block;
based on the first audio block belonging to the target audio block, determining whether the speech quality of the first audio segment in the first audio block is higher than that of the second audio segment of the first audio block;
based on the speech quality of the first audio segment being higher than that of the second audio segment, determining whether the speech quality of the first audio segment is higher than that of the target audio segment determined for the second audio block; and
determining the target audio segment corresponding to each sound source for the first audio block based on a comparison of speech quality of the first audio segment and the target audio segment determined for the second audio block.

5. The method of claim 3, wherein the determining the corresponding target audio segment for the audio block of the plurality of audio blocks comprises:
for each sound source that has been separated, determining whether the first audio block belongs to a target audio block based on the speech quality of the first audio block;
based on the first audio block belonging to target audio block, determining the speech quality of each audio segment in the first audio block, and selecting a third audio segment with the highest speech quality in the first audio block;
determining whether the speech quality of the third audio segment is higher than that of the target audio segment determined for the second audio block; and
determining the target audio segment corresponding to each sound source for the first audio block based on a comparison between the speech quality of the third audio segment and the target audio segment determined for the second audio block.

6. The method of claim 5, wherein the determining the target audio segment corresponding to each sound source for the first audio block comprises:
based on the speech quality of the first audio segment or the third audio segment being higher than that of the target audio segment determined for the second audio block, determining the first audio segment or the third audio segment as the target audio segment; and
based on the speech quality of the first audio segment or the third audio segment being lower than that of the target audio segment determined for the second audio block, determining the first audio segment or the third audio segment as the target audio segment if a difference between the speech quality of the first audio segment or the third audio segment and that of the target audio segment determined for the second audio block is less than a preset threshold and a time interval between the first audio segment or the third audio segment and the target audio segment determined for the second audio block is greater than a time threshold.

7. The method of claim 2, wherein the speech distortion is determined by calculating correlation between a separated speech signal for an audio segment and a reference audio signal, wherein the reference audio signal is an audio signal obtained by subtracting the separated speech signal from an original audio signal corresponding to the audio segment.

8. The method of claim 2, wherein the signal-to-noise ratio is determined by calculating a ratio between a separated speech signal for an audio segment and an original audio signal corresponding to the audio segment.

9. The method of claim 3, wherein the performing speech separation on the first audio segment from the first audio block comprises:
obtaining hidden layer state information of the target audio segment and the second audio segment;
fusing the hidden layer state information of the target audio segment and the second audio segment to obtain fused hidden layer state information; and
performing speech separation on the first audio segment based on the fused hidden layer state information.

10. The method of claim 9, wherein the hidden layer state information is obtained when speech separation is performed on the target audio segment and the second audio segment respectively; and
the hidden layer state information comprises at least one of short-term speech features, long-term speech features and context features of each sound source.

11. The method of claim 10, wherein the first audio segment comprises a plurality of audio units, and
wherein the performing speech separation on the current audio segment based on the fused hidden layer state information comprises:
performing speech separation for each audio unit, to obtain a first separated signal of the first audio segment; and
performing speech separation on the first separated signal based on the fused hidden layer state information, to obtain the separated speech signal of the first audio segment for each sound source.

12. An electronic device comprising:
at least one memory storing computer executable instructions; and
at least one processor, when executing the stored instructions, is configured to:
obtain an audio signal comprising a speech signal uttered by at least one sound source;
determine a target audio segment of the audio signal, wherein the target audio segment is determined based on a speech quality of at least one audio segment, wherein the at least audio segment is divided from the audio signal; and
perform speech separation on the audio signal based on the target audio segment to obtain at least one separated speech signal corresponding to the at least one sound source.

13. A non-transitory computer readable storage medium storing instructions that, when executed by at least one processor, cause the at least one processor to:
obtain an audio signal comprising a speech signal uttered by at least one sound source;
determine a target audio segment of the audio signal, wherein the target audio segment is determined based on a speech quality of at least one audio segment, wherein the at least audio segment is divided from the audio signal; and
perform speech separation on the audio signal based on the target audio segment to obtain at least one separated speech signal corresponding to the at least one sound source.

14. The non-transitory computer readable storage medium of claim 13, wherein the determining the target audio segment of the audio signal comprises:
dividing the audio signal into a plurality of audio blocks according to a first time period and dividing at least one audio block among the plurality of audio blocks into a plurality of audio segments according to a second time period; and
determining a corresponding target audio segment for a audio block among the plurality of audio blocks;
wherein the performing speech separation on the audio signal comprises:
performing speech separation on a first audio segment from a first audio block, based on a target audio segment determined for a second audio block than the first audio block and a second audio segment of the first audio segment, to obtain the at least one separated speech signal corresponding to the at least one sound source.

15. The non-transitory computer readable storage medium of claim 13, wherein the determining the corresponding target audio segment for the audio block comprises:
for each sound source that has been separated, determining whether the first audio block belongs to a target audio block based on the speech quality of the first audio block;
based on the first audio block belonging to the target audio block, determining whether the speech quality of the first audio segment in the first audio block is higher than that of the second audio segment of the first audio block;
based on the speech quality of the first audio segment being higher than that of the second audio segment, determining whether the speech quality of the first audio segment is higher than that of the target audio segment determined for the second audio block; and
determining the target audio segment corresponding to each sound source for the first audio block based on a comparison of speech quality of the first audio segment and the target audio segment determined for the second audio block.

16. The non-transitory computer readable storage medium of claim 14, wherein the determining the corresponding target audio segment for the audio block of the plurality of audio blocks comprises:
for each sound source that has been separated, determining whether the first audio block belongs to a target audio block based on the speech quality of the first audio block;
based on the first audio block belonging to target audio block, determining the speech quality of each audio segment in the first audio block, and selecting a third audio segment with the highest speech quality in the first audio block;
determining whether the speech quality of the third audio segment is higher than that of the target audio segment determined for the second audio block; and
determining the target audio segment corresponding to each sound source for the first audio block based on a comparison between the speech quality of the third audio segment and the target audio segment determined for the second audio block.

17. The non-transitory computer readable storage medium of claim 16, wherein the determining the target audio segment corresponding to each sound source for the first audio block comprises:
based on the speech quality of the first audio segment or the third audio segment being higher than that of the target audio segment determined for the second audio block, determining the first audio segment or the third audio segment as the target audio segment; and
based on the speech quality of the first audio segment or the third audio segment being lower than that of the target audio segment determined for the second audio block, determining the first audio segment or the third audio segment as the target audio segment if a difference between the speech quality of the first audio segment or the third audio segment and that of the target audio segment determined for the second audio block is less than a preset threshold and a time interval between the first audio segment or the third audio segment and the target audio segment determined for the second audio block is greater than a time threshold.

18. The non-transitory computer readable storage medium of claim 14, wherein the performing speech separation on the first audio segment from the first audio block comprises:
obtaining hidden layer state information of the target audio segment and the second audio segment;
fusing the hidden layer state information of the target audio segment and the second audio segment to obtain fused hidden layer state information; and
performing speech separation on the first audio segment based on the fused hidden layer state information.

19. The method of claim 18, wherein the hidden layer state information is obtained when speech separation is performed on the target audio segment and the second audio segment respectively; and
the hidden layer state information comprises at least one of short-term speech features, long-term speech features and context features of each sound source.

20. The method of claim 19, wherein the first audio segment comprises a plurality of audio units, and
wherein the performing speech separation on the current audio segment based on the fused hidden layer state information comprises:
performing speech separation for each audio unit, to obtain a first separated signal of the first audio segment; and
performing speech separation on the first separated signal based on the fused hidden layer state information, to obtain the separated speech signal of the first audio segment for each sound source.
